(19) United States
(12) Patent Application Publication
(10) Pub. No.: US 2026/0097866 A1
(43) Pub. Date: Apr. 9, 2026

(54) Quadrotor Including Multiple Independently Articulable Rotor Systems

(71) Applicant: The Regents of The University of Michigan, Ann Arbor, MI (US)

(72) Inventors: Andrew ZHAO, Ann Arbor, MI (US); Vasileios TZOUMAS, Ann Arbor, MI (US); Atharva NAVSALKAR, Ann Arbor, MI (US)

(73) Assignee: The Regents of The University of Michigan, Ann Arbor, MI (US)

(21) Appl. No.: 19/345,590

(22) Filed: Sep. 30, 2025

Related U.S. Application Data
(60) Provisional application No. 63/703,312, filed on Oct. 4, 2024.

(51) Int. Cl. B64U 30/297; B64U 10/14; B64U 30/24; B64U 50/19

(52) U.S. Cl. CPC B64U 30/297; B64U 10/14; B64U 30/24; B64U 50/19

(57) ABSTRACT

A quadrotor includes a body including a platform. A power source is positioned on the platform. A controller is positioned on the platform and operationally connected to the power source. A first rotor system is operatively connected to the controller and the power source. A second rotor system is operatively connected to the controller and the power source. A third rotor system is operatively connected to the controller and the power source, and a fourth rotor system is operatively connected to the controller and the power source. The controller is configured to articulate each of the first rotor system, the second rotor system, the third rotor system and the fourth rotor system about at least one axis independent of others of the first rotor system, the second rotor system, the third rotor system and the fourth rotor system.

### CROSS-REFERENCE TO RELATED APPLICATIONS

This application claims the benefit and priority of U.S. Provisional Application No. 63/703,312 filed on Oct. 4, 2024. The entire disclosure of the above application is incorporated herein by reference.

### FIELD

The present disclosure relates to the art of radio controlled and autonomous drones and, more particularly, to a quadrotor including multiple, independently articulable, rotor systems.

### BACKGROUND

Remotely controlled air vehicles or drones come in many sizes and configurations. Drones may include propellers that pull, propellers the push, propellers that lift or, in the case of a quad rotor, propellers that may act along more than one axis. A quad rotor includes a body that supports a power supply, a control system, a sensing system, a computation system, and a communication system. The body also supports four articulable rotor assemblies that each house a rotor system. The four articulable rotor bodies and rotor systems are selectively controlled to produce stable flight. Quad rotors may move forward, rearward, or at angles. Quadrotors may also hover in place.

Quadrotor flight is controlled by sending signals to opposing rotor bodies to change position from, for example, a horizontal orientation for hover to an angled orientation for directed flight, and then back to horizontal for hover. The direction of the directed flight would depend on the angle induced to the rotor bodies. However, regardless of the direction, the rotor bodies are controlled in pairs. A change in orientation of one rotor body is mirrored in the rotor body oppositely arranged. This coupled control is used to ensure control authority and/or stability in direct flight. In addition to coupled control, hover is only achieved when rotor systems are in a horizontal configuration with respect to the ground.

This section provides background information related to the present disclosure which is not necessarily prior art.

### SUMMARY

This section provides a general summary of the disclosure and is not a comprehensive disclosure of its full scope or all of its features.

A quadrotor, in accordance with the present disclosure, includes a body including a platform. The platform includes a forward end, an aft end, a first side, and a second side. A power source is positioned on the platform. A controller is positioned on the platform and operationally connected to the power source. A first rotor system positioned at the first side of the platform at the forward end and operatively connected to the controller and the power source. A second rotor system is positioned at the second side of the platform at the aft end and operatively connected to the controller and the power source. A third rotor system is positioned at the first side of the platform at the forward end and operatively connected to the controller and the power source, and a fourth rotor system is positioned at the second side of the platform at the aft end and operatively connected to the controller and the power source. The controller is configured to articulate each of the first rotor system, the second rotor system, the third rotor system and the fourth rotor system about at least one axis independent of others of the first rotor system, the second rotor system, the third rotor system and the fourth rotor system.

In other features, the first rotor system includes a first rotor housing having a first support shaft that is articulable relative to the platform about a first axis, and a first rotor member mounted to the first rotor housing through a first rotor shaft, the first rotor shaft being articulable relative to the first rotor housing about a second axis that is substantially perpendicular relative to the first axis.

In other features, the first rotor member includes a first propeller connected to the first rotor shaft through a first motor and a second propeller connected to the first rotor shaft through a second motor the first motor driving the first propeller in a first direction and the second motor driving the second propeller in a second direction that is opposite the first direction.

In other features, the second rotor system includes a second rotor housing having a second support shaft that is articulable relative to the platform about the first axis, and a second rotor member mounted to the second rotor housing through a second rotor shaft, the second rotor shaft being articulable relative to the second rotor housing about a third axis that is substantially perpendicular relative to the first axis.

In other features, the third rotor system includes a third rotor housing having a third support shaft that is articulable relative to the platform about a fourth axis that is substantially parallel to the first axis, and a third rotor member mounted to the third rotor housing through a third rotor shaft, the third rotor shaft being articulable relative to the third rotor housing about a fifth axis that is substantially perpendicular relative to the fourth axis.

In other features, the fourth rotor system includes a fourth rotor housing having a fourth support shaft that is articulable relative to the platform about the fourth axis, and a fourth rotor member mounted to the fourth rotor housing through a fourth rotor shaft, the fourth rotor shaft being articulable relative to the fourth rotor housing about a seventh axis that is substantially perpendicular relative to the fourth axis.

In other features, a first servo connects the first support shaft with the platform and a second servo connects the first rotor shaft with the first rotor housing.

In other features, a third servo connects the second support shaft with the platform and a fourth servo connects the second rotor shaft with the second rotor housing.

In other features, a fifth servo connects the third support shaft with the platform and a sixth servo connects the third rotor shaft with the third rotor housing.

In other features, a seventh servo connects the fourth support shaft with the platform and an eighth servo connects the fourth rotor shaft with the fourth rotor housing.

A drone, in accordance with the present disclosure, includes a body including a platform. The platform includes a forward end, an aft end, a first side, and a second side. A power source is positioned on the platform. A controller positioned on the platform and operationally connected to the power source. A plurality of rotors is connected to the platform the power source, and the controller. Each of the plurality of rotors is independently articulable about two axis independent of each of the other rotors of the plurality of rotors.

In other features, the plurality of rotors includes a first rotor system, a second rotor system, a third rotor system, and a fourth rotor system.

In other features, the first rotor system includes a first rotor housing and a first rotor member, the first rotor housing having a first support shaft connected to the platform through a first gimbal, the first support shaft being articulable relative to the platform about a first axis, the first rotor member being mounted to the first rotor housing through a first rotor shaft, the first rotor shaft being articulable relative to the first rotor housing about a second axis that is substantially perpendicular relative to the first axis.

In other features, the second rotor system includes a second rotor housing and a second rotor member, the second rotor housing having a second support shaft connected to the platform through a second gimbal, the second support shaft being articulable relative to the platform about the first axis, the second rotor member being mounted to the second rotor housing through a second rotor shaft, the second rotor shaft being articulable relative to the second rotor housing about a third axis that is substantially perpendicular relative to the first axis.

In other features, the third rotor system includes a third rotor housing and a third rotor member, the third rotor housing having a third support shaft mounted to the platform through a third gimbal, the third support shaft being articulable relative to the platform about a fourth axis that is substantially parallel to the first axis, the third rotor member being mounted to the third rotor housing through a third rotor shaft, the third rotor shaft being articulable relative to the third rotor housing about a fifth axis that is substantially perpendicular relative to the fourth axis.

In other features, the fourth rotor system includes a fourth rotor housing and a fourth rotor member, the fourth rotor housing having a fourth support shaft that mounted to the platform through a fourth gimbal, the fourth support shaft being articulable relative to the platform about the fourth axis, and the fourth rotor member being mounted to the fourth rotor housing through a fourth rotor shaft, the fourth rotor shaft being articulable relative to the fourth rotor housing about a seventh axis that is substantially perpendicular relative to the fourth axis.

In other features, a first servo connects the first support shaft with the platform and a second servo connects the first rotor shaft with the first rotor housing.

In other features, a third servo connects the second support shaft with the platform and a fourth servo connects the second rotor shaft with the second rotor housing.

In other features, a fifth servo connects the third support shaft with the platform and a sixth servo connects the third rotor shaft with the third rotor housing.

In other features, a seventh servo connects the fourth support shaft with the platform and an eighth servo connects the fourth rotor shaft with the fourth rotor housing.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is an upper left perspective view of a quadrotor including multiple, independently articulable rotor systems, in accordance with the present disclosure;

FIG. 2 is a perspective view of a first one of the multiple, independently articulable rotor systems, in accordance with the present disclosure;

FIG. 3 is a perspective view of a second one of the multiple, independently articulable rotor systems, in accordance with the present disclosure;

FIG. 4 is a perspective view of a third one of the multiple, independently articulable rotor systems, in accordance with the present disclosure;

FIG. 5 is a perspective view of a fourth one of the multiple, independently articulable rotor systems, in accordance with the present disclosure;

FIG. 6 is a perspective view of the quadrotor of FIG. 1, in a first flight orientation, in accordance with the present disclosure;

FIG. 7 is a perspective view of the quadrotor of FIG. 6 in a second flight orientation, in accordance with the present disclosure;

FIG. 8 is a perspective view of the quadrotor of FIG. 7 in a third flight orientation, in accordance with the present disclosure;

FIG. 9 is a perspective view of the quadrotor of FIG. 8 in a fourth flight orientation, in accordance with the present disclosure;

FIG. 10 is a perspective view of the quadrotor of FIG. 9 in a fifth flight orientation, in accordance with the present disclosure;

FIG. 11 is a perspective view of the quadrotor of FIG. 10 in a sixth flight orientation, in accordance with the present disclosure;

FIG. 12 is a schematic view of a flight controller for the quadrotor, in accordance with the present disclosure; and

FIG. 13 is a schematic diagram depicting unit vectors along a yaw direction for each rotor of the quadrotor, in accordance with the present disclosure.

Corresponding reference numerals indicate corresponding parts throughout the several views of the drawings.

### DETAILED DESCRIPTION

Example embodiments will now be described more fully with reference to the accompanying drawings.

As drones grow in popularity, their use as tools also grows. Drones serve as photography platforms, sensor platforms, delivery platforms and the like. Currently, operating a drone to control and use a tool is difficult. The drone is only capable of hovering when its body and all rotors are horizontal with respect to the ground. As such precise positioning and manipulation of the tool is nearly impossible.

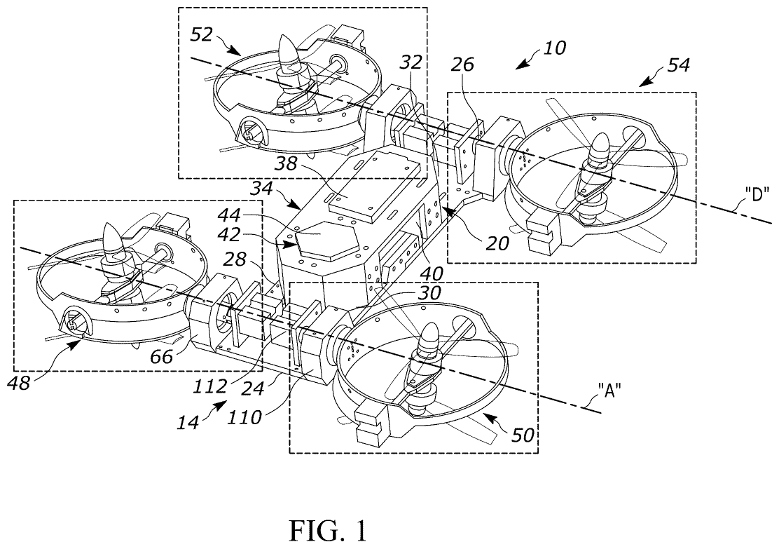

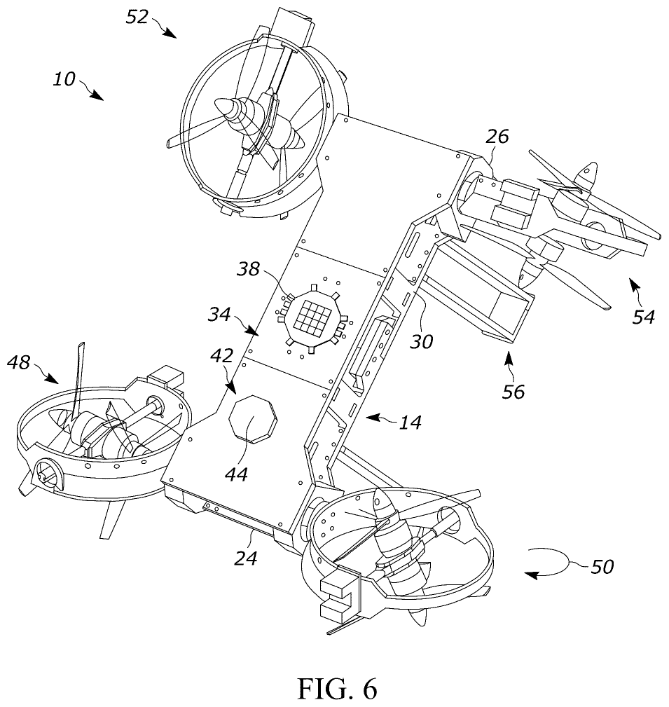

A drone, shown in the form of a quadrotor in FIG. 1 is indicated generally at 10. Quadrotor 10 includes a body 14 defined by a platform 20 having a forward end 24, an aft end 26 (FIG. 6), a first side 28, and a second side 30. First side 28 and second side 30 extend between and connect with forward end 24 and aft end 26. Platform 20 also includes an upper surface 32 that supports a housing 34. Body 14 may include a plurality of support members such as shown at 36 in FIG. 6. A flight controller 38 is provided in housing 34. In addition to supporting flight controller 38, housing 34 also supports a battery or power source 40, a receiver 42 including an antenna 44. At this point, it should be recognized that while shown as a quad rotor, the drone may have any number of rotors greater than unity.

In accordance with the present disclosure, quadrotor 10 includes a first rotor system 48, a second rotor system 50, a third rotor system 52, and a fourth rotor system 54. As will be detailed more fully herein each rotor system is articulable about two distinct axes. In addition, rotor systems 48, 50, 52, and 54 are decoupled from one another. More specifically, movement, i.e., articulation of any one of the first rotor system 48, second rotor system 50, third rotor system 52, and fourth rotor system 54 is independent of all the other rotor systems.

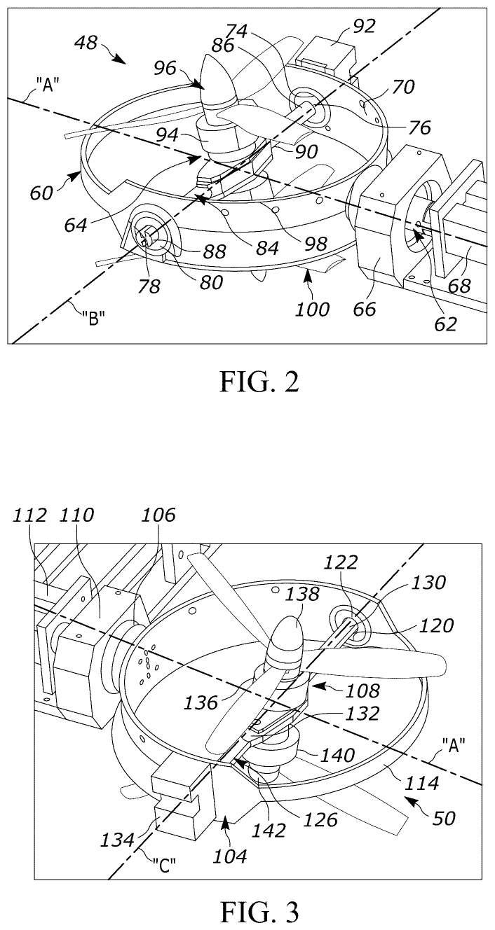

As shown in FIG. 2, first rotor system 48 includes a first rotor housing 60 connected to a first support shaft 62 and surrounds a first rotor member 64. First support shaft 62 is supported in a first gimbal 66 provided on upper surface 32 of platform 20 at forward end 24. First gimbal 66 is aligned with first side 28 and supports rotary movement of first support shaft 62 about a first axis of rotation “A” provided by a first servo 68. First servo 68 is operatively connected to flight controller 38 as well as battery 40.

First rotor housing 60 includes a first support wall 70 having a first passage 74 supporting a first bearing 76 and a second passage 78 supporting a second bearing 80. Second passage 78 is spaced 180° from first passage 74. A first rotor shaft 84 supports first rotor member 64 and extends between first bearing 76 and second bearing 80. First rotor shaft 84 includes a first end 86, a second end 88, and an intermediate portion 90 that extends between first end 86 and a second end 88. First end 86 projects outward from first bearing 76 and is connected to a second servo 92. Second servo 92 rotates first rotor shaft 84 about a second axis “B” that is substantially perpendicular to first axis “A”. Second servo 92 is operatively connected to flight controller 38 as well as battery 40.

First rotor member 64 includes a first motor 94 connected to a first propeller 96 and a second motor 98 connected to a second propeller 100. First motor 94 and second motor 96 are operatively connected to flight controller 38 as well as battery 40. First motor 94 rotates, first propeller 96 about a first propeller axis and second motor 96 rotates second propeller 100 about the first propeller axis. While the axis of rotation may be shared, the direction of rotation of first propeller 96 and second propeller 100 are opposites. In this manner, when in operation, drag forces generated by first propeller 96 are cancelled out by drag forces created by second propeller 100. Similarly, when in operation, the angular momentum produced by first propeller 96 is cancelled out by the angular momentum produced by second propeller 100.

Referring to FIG. 3, second rotor system 50 includes a second rotor housing 104 connected to a second support shaft 106 and surrounds a second rotor member 108. Second support shaft 106 is supported in a second gimbal 110 provided on upper surface 32 of platform 20 at forward end 24. Second gimbal 110 is aligned with second side 30 and supports rotary movement of second support shaft 106 about the first axis of rotation “A” provided by a third servo 112. Third servo 112 is operatively connected to flight controller 38 as well as battery 40.

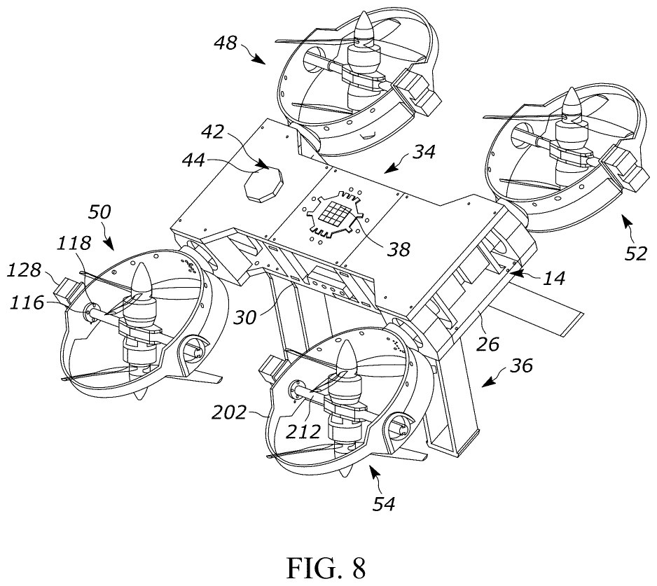

Second rotor housing 104 includes a second support wall 114 having a first passage 116 supporting a first bearing 118 (FIG. 8) and a second passage 120 supporting a second bearing 122. Second passage 120 is spaced 180° from first passage 116. A second rotor shaft 126 supports second rotor member 108 and extends between first bearing 118 and second bearing 122. Second rotor shaft 126 includes a first end 128, a second end 130, and an intermediate portion 132 that extends between first end 128 and a second end 130. First end 128 projects outward from first bearing 118 and is connected to a fourth servo 134. Fourth servo 134 rotates second rotor shaft 126 about a fourth axis “C” that is substantially perpendicular to first axis “A”. Fourth servo 134 is operatively connected to flight controller 38 as well as battery 40.

Second rotor member 108 includes a third motor 136 connected to a third propeller 138 and a fourth motor 140 connected to a fourth propeller 142. Third motor 136 and fourth motor 140 are operatively connected to flight controller 38 as well as battery 40. Third motor 136 rotates third propeller 138 about a second propeller axis and fourth motor 140 rotates fourth propeller 142 about the second propeller axis. While the axis of rotation may be shared, the direction of rotation of third propeller 138 and fourth propeller 142 are opposites. In this manner, when in operation, drag forces generated by third propeller 138 are cancelled out by drag forces created by fourth propeller 142. Similarly, when in operation, the angular momentum produced by third propeller 138 is cancelled out by the angular momentum produced by fourth propeller 142.

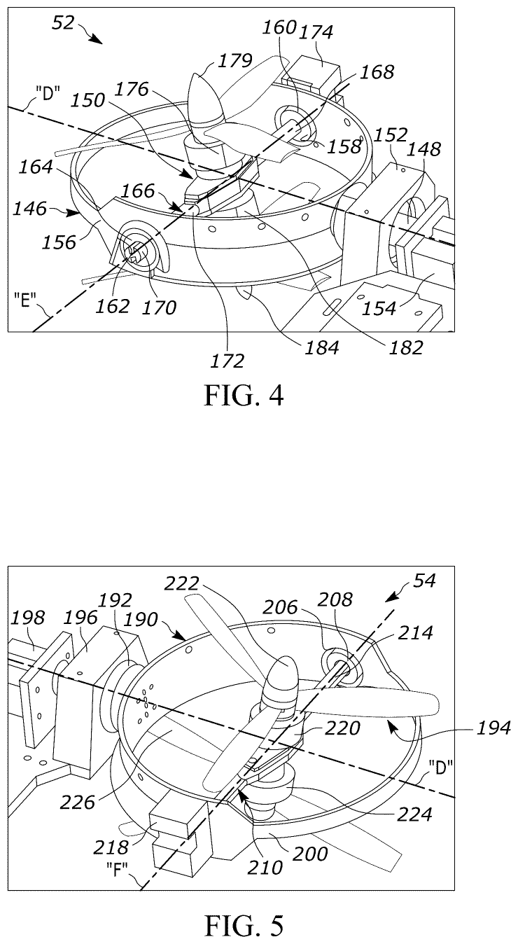

Turning to FIG. 4, third rotor system 52 includes a third rotor housing 146 connected to a third support shaft 148 and surrounds a third rotor member 150. Third support shaft 148 is supported in a third gimbal 152 provided on upper surface 32 of platform 20 at aft end 26. Third gimbal 152 is aligned with first side 28 and supports rotary movement of third support shaft 148 about a fifth axis of rotation “D” provided by a fifth servo 154. Fifth axis of rotation “D” is substantially parallel to first axis of rotation “A”. Fifth servo 154 is operatively connected to flight controller 38 as well as battery 40.

Third rotor housing 146 includes a third support wall 156 having a first passage 158 supporting a first bearing 160 and a second passage 162 supporting a second bearing 164. Second passage 162 is spaced 180° from first passage 158. A third rotor shaft 166 supports third rotor member 150 and extends between first bearing 160 and second bearing 164. Third rotor shaft 166 includes a first end 168, a second end 170, and an intermediate portion 172 that extends between first end 168 and a second end 170. First end 168 projects outward from first bearing 160 and is connected to a sixth servo 174. Sixth servo 174 rotates third rotor shaft 166 about a sixth axis “E” that is substantially perpendicular to fifth axis of rotation “D”. Sixth servo 174 is operatively connected to flight controller 38 as well as battery 40.

Third rotor member 150 includes a fifth motor 176 connected to a fifth propeller 179 and a sixth motor 182 connected to a sixth propeller 184. Fifth motor 176 and sixth motor 182 are connected to intermediate portion 172 of third rotor shaft 166. Fifth motor 176 and sixth motor 182 are operatively connected to flight controller 38 as well as battery 40. Fifth motor 176 rotates fifth propeller 179 about a third propeller axis and sixth motor 182 rotates sixth propeller 184 about the third propeller axis. While the axis of rotation may be shared, the direction of rotation of fifth propeller 179 and sixth propeller 184 are opposites. In this manner, when in operation, drag forces generated by fifth propeller 179 are cancelled out by drag forces created by sixth propeller 184. Similarly, the angular momentum produced by fifth propeller 179 is cancelled out by the angular momentum produced by sixth propeller 184.

Referring to FIG. 5, fourth rotor system 54 includes a fourth rotor housing 190 connected to a fourth support shaft 192 and surrounds a fourth rotor member 194. Fourth support shaft 192 is supported in a fourth gimbal 196 provided on upper surface 32 of platform 20 at aft end 26. Fourth gimbal 196 is aligned with second side 30 and supports rotary movement of fourth support shaft 192 about the fifth axis of rotation “D” provided by a seventh servo 198. Seventh servo 198 is operatively connected to flight controller 38 as well as battery 40. Similarly, when in operation, the angular momentum produced by fifth propeller 179 is cancelled out by the angular momentum produced by sixth propeller 184.

Fourth rotor housing 190 includes a fourth support wall 200 having a first passage 202 supporting a first bearing 204 (FIG. 8) and a second passage 206 supporting a second bearing 208. Second passage 206 is spaced 180° from first passage 202. A fourth rotor shaft 210 supports fourth rotor member 194 and extends between first bearing 204 and second bearing 208. Fourth rotor shaft 210 includes a first end 212, a second end 214, and an intermediate portion 216 that extends between first end 212 and a second end 214. First end 212 projects outward from first bearing 204 and is connected to an eighth servo 218. Eighth servo 218 rotates fourth rotor shaft 210 about the sixth axis “F” that is substantially perpendicular to fifth axis of rotation “D”. Eighth servo 218 is operatively connected to flight controller 38 as well as battery 40.

Fourth rotor member 194 includes a seventh motor 220 connected to a seventh propeller 222 and an eighth motor 224 connected to an eighth propeller 226. Seventh motor 220 and eighth motor 224 are connected to intermediate portion 216 of fourth rotor shaft 210. Seventh motor 220 and eighth motor 224 are operatively connected to flight controller 38 as well as battery 40. Seventh motor 220 rotates seventh propeller 222 about a fourth propeller axis and eighth motor 224 rotates eighth propeller 226 about the fourth propeller axis. While the axis of rotation may be shared, the direction of rotation of seventh propeller 222 and eighth propeller 226 are opposites. In this manner, when in operation, drag forces generated by seventh propeller 222 are cancelled out by drag forces created by eighth propeller 226. Similarly, when in operation, the angular momentum produced by seventh propeller 222 is cancelled out by the angular momentum produced by eighth propeller 226.

As will be detailed more fully herein, first rotor system 48, second rotor system 50, third rotor system 52, and fourth rotor system 54 are independently orientable to establish a desired flight attitude of quadrotor 10. As shown in FIG. 6, each of the first rotor system 48, second rotor system 50, third rotor system 52, and fourth rotor system 54 may be oriented at a different rotation position about the first axis “A” and the fourth axis “D”. More specifically, first rotor system 48 is decoupled from second rotor system 50, third rotor system 52, and fourth rotor system 54; second rotor system 50 is decoupled from first rotor system 48, third rotor system 52, and fourth rotor system 54; third rotor system 52 is decoupled from first rotor system 48, second rotor system 50, and fourth rotor system 54; and fourth rotor system 54 is decoupled from first rotor system 48, second rotor system 50, and third rotor system 52.

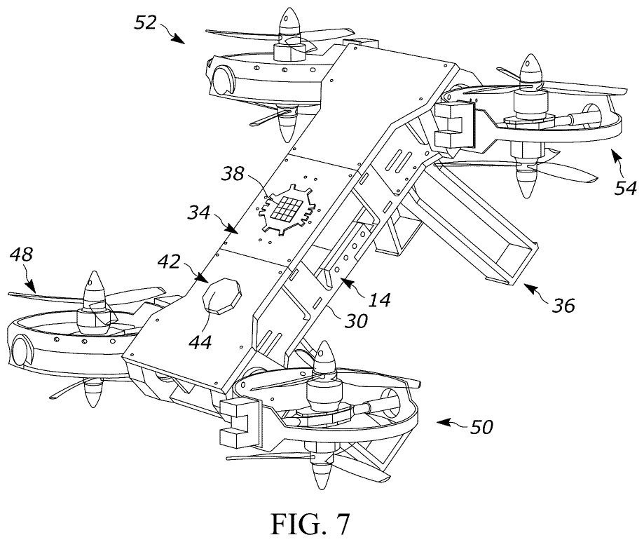

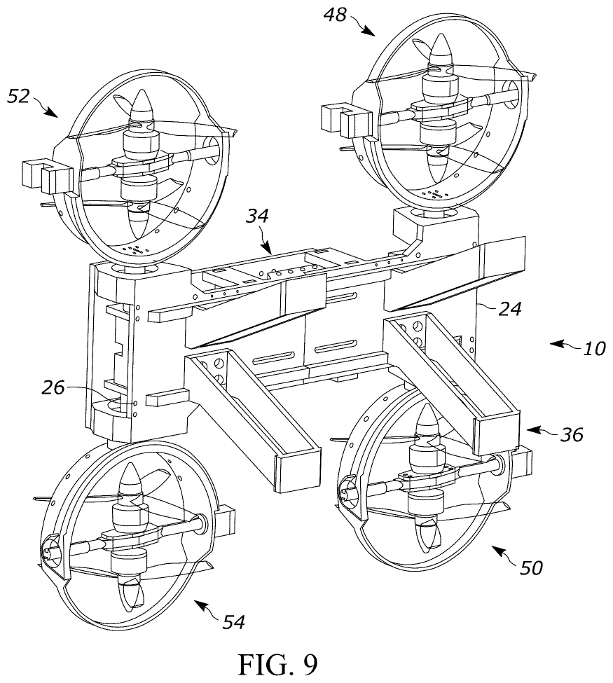

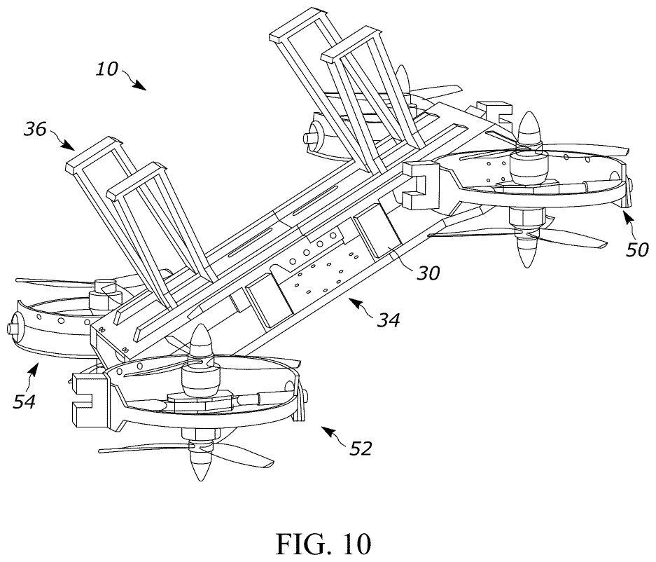

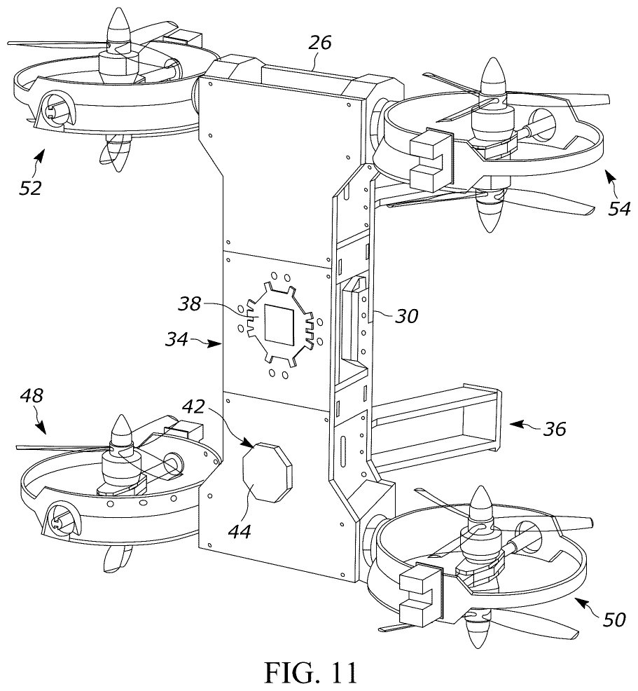

With this arrangement, quadrotor 10 may take on one of any number of flight attitudes such as shown in FIGS. 6, 7, 8, 9, 10, and 11. Body 14 may be angled relative to a horizontal axis such as shown in FIGS. 6, 7, and 11, may be rotated relative to the horizonal axis such as shown in FIGS. 8 and 9, or body 14 may have a multi-axis orientation such as shown in FIG. 10. The flexibility provided by decoupling each of the first rotor system 48, second rotor system 50, third rotor system 52, and fourth rotor system 54 from any other of the first rotor system 48, second rotor system 50, third rotor system 52, and fourth rotor system 54 allows for a unique flight envelope that may be employed in various endeavors such as tracking, surveillance, tool manipulation, and the like.

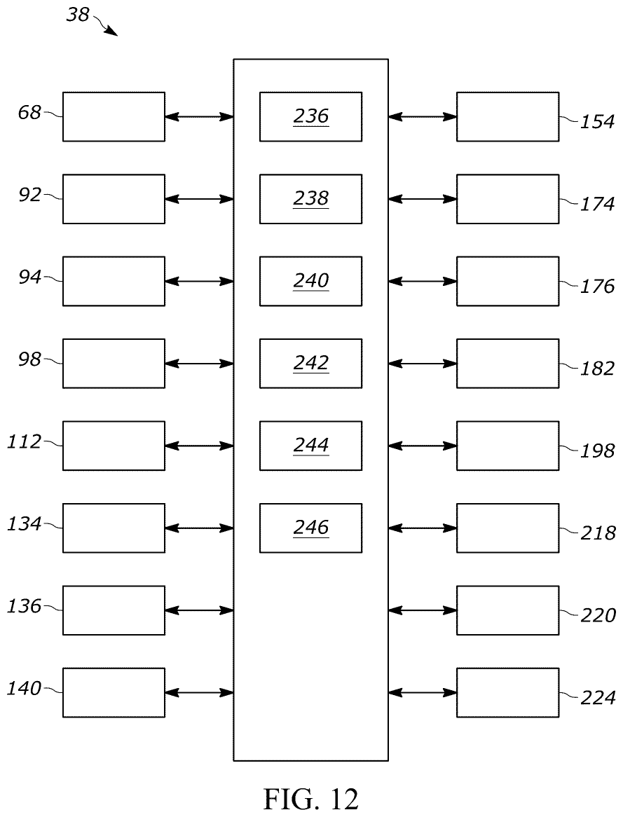

Referring to FIG. 12, flight controller 38 includes a central processing unit (CPU) 236, a rotor housing control module 238, a rotor member control module 240, a feedback control module 242, a rotor control module 244, and a non-transient memory 246. Flight controller 38 receives signals from receiver 42 commanding a direction of flight. Rotor housing control module 238 directs one or more of the first rotor housing 60, second rotor housing 104, third rotor housing 146 and/or fourth rotor housing 190 to rotate about their respective axes to a selected position. Concurrently, rotor member control module 240 commands one or more of first rotor member 64, second rotor member 108, third rotor member 150 and or fourth rotor member 194 to rotate about their respective axes to a selected position. The selected position corresponds to the directed flight direction.

As the rotor housings and rotor members articulate, each of the servos provides position feedback to feedback control module 242. Position feedback may be provided through rotary encoders (not shown) associated with corresponding ones of first servo 68. Second servo 92, third servo 112. Fourth servo 134, fifth servo 154, sixth servo 174, seventh servo 198, and eighth servo 218.

The position feedback is processed and used by rotor housing control module 238 and rotor member control module 240 to adjust each of the first rotor housing 60, second rotor housing 104, third rotor housing 146 and/or fourth rotor housing 190 and each of the first rotor member 64, second rotor member 108, third rotor member 150 and or fourth rotor member 194 to achieve stable flight at a commanded orientation of platform 22. By utilizing independently controllable rotor systems, flight controller 38 may achieve hover with platform 20 being in any commanded position and orientation without the need for each of the first rotor housing 60, second rotor housing 104, third rotor housing 146 and/or fourth rotor housing 190 to be in a horizontal orientation with respect to body 14 of quadrotor 10.

In accordance with the present disclosure, flight controller allocates commands to each rotor system 48, 50, 52, and 54 to establish a selected flight orientation and translation for quadrotor 10. Command or control allocation refers to how high-level control commands translate to low-level motor commands. In accordance with the present disclosure, flight controller 38 can control the direction and magnitude of the thrust (basically the individual thrust vectors “ti|B in body-fixed frame B) for each rotor system 48, 50, 52, and 54. For example, each rotor system 48, 50, 52, and 54 can be controlled to generate an independent thrust vector. The low-level commands αi, βi and Ωi for one rotor system are decoupled with the values for the other rotor systems. In this manner, the value of individual thrust vectors “ti|B, can be used to determine find the command values αi, βi and Ωi. Note that, in a non-limiting example, the magnitude of ∥ti|B∥ determines the angular velocity of the propeller Ωi and direction ti|B determines the values of servo motor angles αᵢ and βᵢ.

Thrust vectors are calculated by breaking down the commanded force and torque values f′desired, “rdesired into four separate components, four components viz., net force, roll, pitch and yaw. Each of the four components is equally (in magnitude) distributed to each rotor systems 48, 50, 52, and 54 such a components sent to one rotor system does not affect the other component. Mathematically, each thrust vector “ti|B is a vector sum of it's contribution towards net force, roll, pitch and yaw. This is given by

$${\vec{t}}_{1 \vert ℬ} = \frac{\vec{f}}{4} + ( \frac{{τ}_{{\hat{ι}}_{ℬ}}}{4 b} ) {\hat{k}}_{ℬ} + ( \frac{- {τ}_{{\hat{J}}_{ℬ}}}{4 l} ) {\hat{k}}_{ℬ} + ( \frac{{τ}_{{\hat{k}}_{ℬ}}}{4 r} ) {\hat{t}}_{{ψ}_{1}} \qquad ( 1 )$$

$${\vec{t}}_{2 \vert ℬ} = \frac{\vec{f}}{4} + ( \frac{- {τ}_{{\hat{ι}}_{ℬ}}}{4 b} ) {\hat{k}}_{ℬ} + ( \frac{- {τ}_{{\hat{J}}_{ℬ}}}{4 l} ) {\hat{k}}_{ℬ} + ( \frac{{τ}_{{\hat{k}}_{ℬ}}}{4 r} ) {\hat{t}}_{{ψ}_{2}} \qquad ( 2 )$$

$${\vec{t}}_{3 \vert ℬ} = \frac{\vec{f}}{4} + ( \frac{- {τ}_{{\hat{ι}}_{ℬ}}}{4 b} ) {\hat{k}}_{ℬ} + ( \frac{{τ}_{{\hat{J}}_{ℬ}}}{4 l} ) {\hat{k}}_{ℬ} + ( \frac{{τ}_{{\hat{k}}_{ℬ}}}{4 r} ) {\hat{t}}_{{ψ}_{3}} \qquad ( 3 )$$

$${\vec{t}}_{4 \vert ℬ} = \frac{\vec{f}}{4} + ( \frac{{τ}_{{\hat{ι}}_{ℬ}}}{4 b} ) {\hat{k}}_{ℬ} + ( \frac{{τ}_{{\hat{J}}_{ℬ}}}{4 l} ) {\hat{k}}_{ℬ} + ( \frac{{τ}_{{\hat{k}}_{ℬ}}}{4 r} ) {\hat{t}}_{{ψ}_{4}} \qquad ( 4 )$$

The values l, b, and r are the half-length, half-breadth and distance from CoG of each propeller. The vectors \hat{t}_{ψi} are the unit vectors along the yaw directions, in \hat{l}_{B}-ĵ_{B} plane, as shown in FIG. 13. Mathematicaly, these are given by

$${\vec{t}}_{{Ψ}_{1}} = {[ \begin{matrix}\frac{- b}{r} & \frac{l}{r} & 0\end{matrix} ]}^{T} \qquad ( 5 )$$

$${\vec{t}}_{{Ψ}_{2}} = {[ \begin{matrix}\frac{b}{r} & \frac{l}{r} & 0\end{matrix} ]}^{T} \qquad ( 6 )$$

$${\vec{t}}_{{Ψ}_{3}} = {[ \begin{matrix}\frac{b}{r} & \frac{- l}{r} & 0\end{matrix} ]}^{T} \qquad ( 7 )$$

$${\vec{t}}_{{Ψ}_{4}} = {[ \begin{matrix}\frac{- b}{r} & \frac{- l}{r} & 0\end{matrix} ]}^{T} \qquad ( 8 )$$

Once we have values for each component tᵢ we can determine values for αᵢ, βᵢ and Ωᵢ. The expression of ^{→}tᵢ is given by

$${\vec{t}}_{i} = [ \begin{matrix}s {α}_{i} c {β}_{i} \\ - s {β}_{i} \\ c {α}_{i} c β\end{matrix} ] ( {c}_{t} {Ω}_{i}^{2} ) \qquad ( 9 )$$

Note that we have dropped the subscript B for ease of notation. Using the trigonometric relations, we get

$${Ω}_{i} = \sqrt{‖ {\vec{t}}_{i} ‖ / {c}_{t}} , {β}_{i} = - {sin}^{- 1} ( {\hat{t}}_{i , y} ) , {α}_{i} = {sin}^{- 1} ( \frac{{\hat{t}}_{i , x}}{cos {β}_{i}} ) . \qquad ( 10 )$$

Here, we can observe that the above relations restrict the value of di and βᵢ between π/2 and π/2 due to the presence of sin⁻¹. This works well when any individual thrust ^{→}tᵢ has positive z-component, i.e., the thrust has an upward pointing component. We can also intuitively understand why the αi and βᵢ angles would always be in (−π/2, π/2) here. When t_{i,z}<0, i.e., cos αᵢ cos βᵢ<0, it means that either of αᵢ and βᵢ belongs in the range [π/2, π] or [−π, π/2]. We choose a, to be in that range, which means that βi ∈[−π/2, πT/2] always. Hence, we define a following logic to compute the value of di.

$$IF {t}_{i , z} < 0 AND {t}_{i , x} \geq 0 : {a}_{i} = π - {sin}^{- 1} ( \frac{{\hat{t}}_{i , x}}{cos {β}_{i}} ) {α}_{i} ∈ ( π / 2 , π ) \qquad ( 11 )$$

$$ELSE IF {t}_{i , z} < 0 AND {t}_{i , x} < 0 : ELSE : {α}_{i} = - π - {sin}^{- 1} ( \frac{{t}_{i , x}}{cos {β}_{i}} ) {a}_{i} ∈ ( - π , π / 2 ) \text{?}$$

$$\text{?} \text{indicates text missing or illegible when filed}$$

The values of Ωⱼ and βᵢ are computed same as shown previously, where

$${Ω}_{i} = \sqrt{‖ {\vec{t}}_{i} ‖ / {c}_{t}} , \qquad ( 12 )$$

$${β}_{i} = - {sin}^{- 1} ( {\hat{t}}_{i , y} ) \qquad ( 13 )$$

Equations 11, 12 and 13 give the final low-level commands for the actuators. This concludes our control allocation method. In this manner, flight control 38 may independently control each rotor system 48, 50, 52, and 54 to achieve a selected flight orientation. Further, the independent control of each rotor system 48, 50, 52, and 54 allows quadrotor 10 to achieve a level of flight performance previously unachievable by quadrotors having coupled rotor systems.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The terms “about” and “substantially” are intended to include the degree of error associated with measurement of the particular quantity based upon the equipment available at the time of filing the application. For example, “about” and “substantially” can include a range of ±8% of a given value.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A quadrotor comprising:
a body including a platform, the platform including a forward end, an aft end, a first side, and a second side;
a power source positioned on the platform;
a controller positioned on the platform and operationally connected to the power source;
a first rotor system positioned at the first side of the platform at the forward end and operatively connected to the controller and the power source;
a second rotor system positioned at the second side of the platform at the aft end and operatively connected to the controller and the power source;
a third rotor system positioned at the first side of the platform at the forward end and operatively connected to the controller and the power source; and
a fourth rotor system positioned at the second side of the platform at the aft end and operatively connected to the controller and the power source, wherein the controller is configured to articulate each of the first rotor system, the second rotor system, the third rotor system and the fourth rotor system about at least one axis independent of others of the first rotor system, the second rotor system, the third rotor system and the fourth rotor system.

2. The quadrotor according to claim 1, wherein the first rotor system includes a first rotor housing having a first support shaft that is articulable relative to the platform about a first axis, and a first rotor member mounted to the first rotor housing through a first rotor shaft, the first rotor shaft being articulable relative to the first rotor housing about a second axis that is substantially perpendicular relative to the first axis.

3. The quadrotor according to claim 2, wherein the first rotor member includes a first propeller connected to the first rotor shaft through a first motor and a second propeller connected to the first rotor shaft through a second motor the first motor driving the first propeller in a first direction and the second motor driving the second propeller in a second direction that is opposite the first direction.

4. The quadrotor according to claim 2, wherein the second rotor system includes a second rotor housing having a second support shaft that is articulable relative to the platform about the first axis, and a second rotor member mounted to the second rotor housing through a second rotor shaft, the second rotor shaft being articulable relative to the second rotor housing about a third axis that is substantially perpendicular relative to the first axis.

5. The quadrotor according to claim 4, wherein the third rotor system includes a third rotor housing having a third support shaft that is articulable relative to the platform about a fourth axis that is substantially parallel to the first axis, and a third rotor member mounted to the third rotor housing through a third rotor shaft, the third rotor shaft being articulable relative to the third rotor housing about a fifth axis that is substantially perpendicular relative to the fourth axis.

6. The quadrotor according to claim 5, wherein the fourth rotor system includes a fourth rotor housing having a fourth support shaft that is articulable relative to the platform about the fourth axis, and a fourth rotor member mounted to the fourth rotor housing through a fourth rotor shaft, the fourth rotor shaft being articulable relative to the fourth rotor housing about a seventh axis that is substantially perpendicular relative to the fourth axis.

7. The quadrotor according to claim 6, further comprising a first servo connecting the first support shaft with the platform and a second servo connecting the first rotor shaft with the first rotor housing.

8. The quadrotor according to claim 7, further comprising a third servo connecting the second support shaft with the platform and a fourth servo connecting the second rotor shaft with the second rotor housing.

9. The quadrotor according to claim 8, further comprising a fifth servo connecting the third support shaft with the platform and a sixth servo connecting the third rotor shaft with the third rotor housing.

10. The quadrotor according to claim 9, further comprising a seventh servo connecting the fourth support shaft with the platform and an eighth servo connecting the fourth rotor shaft with the fourth rotor housing.

11. A drone comprising:
a body including a platform, the platform including a forward end, an aft end, a first side, and a second side;
a power source positioned on the platform;
a controller positioned on the platform and operationally connected to the power source; and
a plurality of rotors connected to the platform, the power source, and the controller, each of the plurality of rotors being independently articulable about two axis independent of each of the other rotors of the plurality of rotors.

12. The drone according to claim 11, wherein the plurality of rotors includes a first rotor system, a second rotor system, a third rotor system, and a fourth rotor system.

13. The drone according to claim 12, wherein the first rotor system includes a first rotor housing and a first rotor member, the first rotor housing having a first support shaft connected to the platform through a first gimbal, the first support shaft being articulable relative to the platform about a first axis, the first rotor member being mounted to the first rotor housing through a first rotor shaft, the first rotor shaft being articulable relative to the first rotor housing about a second axis that is substantially perpendicular relative to the first axis.

14. The drone according to claim 13, wherein the second rotor system includes a second rotor housing and a second rotor member, the second rotor housing having a second support shaft connected to the platform through a second gimbal, the second support shaft being articulable relative to the platform about the first axis, the second rotor member being mounted to the second rotor housing through a second rotor shaft, the second rotor shaft being articulable relative to the second rotor housing about a third axis that is substantially perpendicular relative to the first axis.

15. The drone according to claim 14, wherein the third rotor system includes a third rotor housing and a third rotor member, the third rotor housing having a third support shaft mounted to the platform through a third gimbal, the third support shaft being articulable relative to the platform about a fourth axis that is substantially parallel to the first axis, the third rotor member being mounted to the third rotor housing through a third rotor shaft, the third rotor shaft being articulable relative to the third rotor housing about a fifth axis that is substantially perpendicular relative to the fourth axis.

16. The drone according to claim 15, wherein the fourth rotor system includes a fourth rotor housing and a fourth rotor member, the fourth rotor housing having a fourth support shaft that mounted to the platform through a fourth gimbal, the fourth support shaft being articulable relative to the platform about the fourth axis, and the fourth rotor member being mounted to the fourth rotor housing through a fourth rotor shaft, the fourth rotor shaft being articulable relative to the fourth rotor housing about a seventh axis that is substantially perpendicular relative to the fourth axis.

17. The drone according to claim 16, further comprising a first servo connecting the first support shaft with the platform and a second servo connecting the first rotor shaft with the first rotor housing.

18. The drone according to claim 17, further comprising a third servo connecting the second support shaft with the platform and a fourth servo connecting the second rotor shaft with the second rotor housing.

19. The drone according to claim 18, further comprising a fifth servo connecting the third support shaft with the platform and a sixth servo connecting the third rotor shaft with the third rotor housing.

20. The drone according to claim 19, further comprising a seventh servo connecting the fourth support shaft with the platform and an eighth servo connecting the fourth rotor shaft with the fourth rotor housing.
